(19) United States
(12) Patent Application Publication
(10) Pub. No.: US 2011/0261074 A1
(43) Pub. Date: Oct. 27, 2011

(54) TOUCH PANEL TYPE INPUT APPARATUS AND POWER CONTROL METHOD OF TOUCH PANEL TYPE INPUT APPARATUS

(75) Inventor: Kazuo Sasama, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/090,340

(22) Filed: Apr. 20, 2011

Related U.S. Application Data
(60) Provisional application No. 61/328,392, filed on Apr. 27, 2010.

(51) Int. Cl. G09G 5/377; G06F 3/041; G06F 3/045

(52) U.S. Cl. 345/634; 345/174; 345/173

(57) ABSTRACT

An input apparatus includes a display part, a touch panel arranged at an upper part of a display area of the display part, and a touch panel control part. The display part displays a button image. The touch panel control part supplies power to the touch panel so that the power is supplied only to an area which is an area of the touch panel and corresponds to an area of the button image displayed on the display part.

### CROSS-REFERENCE TO RELATED APPLICATION

This application is based upon and claims the benefit of priority from: U.S. provisional application 61/328,392, filed on Apr. 27, 2010; the entire contents all of which are incorporated herein by reference.

### FIELD

Embodiments described herein relate generally to a technique for controlling an input from a touch panel.

### BACKGROUND

In a mode other than a power-saving mode, a touch panel used in an image processing apparatus or the like is always in an energized state.

This has a defect (problem) that wasteful power is consumed.

### DESCRIPTION OF THE DRAWINGS

FIG. 1 is a view showing an example of a structure of an image processing apparatus.

FIG. 2 is a block diagram showing a structural example of a control panel unit.

FIG. 3 is a view showing a relation between a position of an input button image and power on and off of a light-emitting element and a light-receiving element of a touch panel.

FIG. 4 is a view showing a relation between a position (another arrangement) of an input button image and power on and off of a light-emitting element and a light-receiving element of a touch panel.

FIG. 5 is a sectional view of a touch panel and an LCD display part.

FIG. 6 is a block diagram of touch detection and screen display in a first embodiment.

FIG. 7 shows a positional relation (touch panel side) between a touch detection area of a touch panel and an input button of an LCD display part in the first embodiment.

FIG. 8 shows a positional relation (LCD display part side) between the touch detection area of the touch panel and the input button of the LCD display part in the first embodiment.

FIG. 9 is a view showing a drive system of the LCD display part.

FIG. 10 is a view showing a touch detection drive circuit of the touch panel in the first embodiment.

FIG. 11 shows a positional relation between a touch detection area of the touch panel and the input button of the LCD display part in the first embodiment.

FIG. 12A and FIG. 12B are timing charts of a touch detection drive circuit in the first embodiment.

FIG. 13 shows a light-emitting element, a light-emitting drive circuit, a light-receiving element and a power (VCC) supply circuit in the first embodiment.

FIG. 14 is a timing chart (in the case of EX0 to EXn=1, EY0 to EYm=1) showing light-emitting states of light-emitting elements (LEDs) and power supply states to light-receiving elements (phototransistors) in the first embodiment.

FIG. 15 is a timing chart (in the case of EX0=0, EX1 to EX3=1, EX4 to EXn=0, EY0=0, EY1 to EY2=1, EY3 to EYm=0) showing light-emitting states of the light-emitting elements (LEDs) and power supply states to the light-receiving elements (phototransistors) in the first embodiment.

FIG. 16 is a flowchart of touch detection and screen display change control in the first embodiment.

FIG. 17 is a view showing vertical direction position detection of a 4-wire resistive touch panel.

FIG. 18 is a view showing a horizontal direction position detection of the 4-wire resistive touch panel.

FIG. 19 is a flowchart showing touch detection of the 4-wire resistive touch panel.

FIG. 20A is a view showing a touch detection method (vertical direction detection in screen portion detection) in a multi-touch system of a 4-wire resistive touch panel in a second embodiment.

FIG. 20B is a view showing the touch detection method (vertical direction detection in screen portion detection is selected in a rectangular shape) in the touch panel of the multi-touch system in the second embodiment.

FIG. 21 is a view showing the touch detection method of an input button area in the multi-touch system of the 4-wire resistive touch panel in the second embodiment.

FIG. 22 is a view for explaining the handling of a grayed out button in the first and the second embodiments and that a power source of only a part of a button area is turned on in the first embodiment.

### DETAILED DESCRIPTION

An input apparatus includes a display part, a touch panel and a touch panel control part. The display part displays one or plural button images. The touch panel is arranged at an upper part of a display area of the display part. The touch panel control part supplies power to the touch panel so that the power is supplied to an area which is an area of the touch panel and corresponds to an area of the button image displayed on the display part.

Hereinafter, a description will be made with reference to the drawings. In the following description, it is assumed that an arrangement position of a button is previously defined.

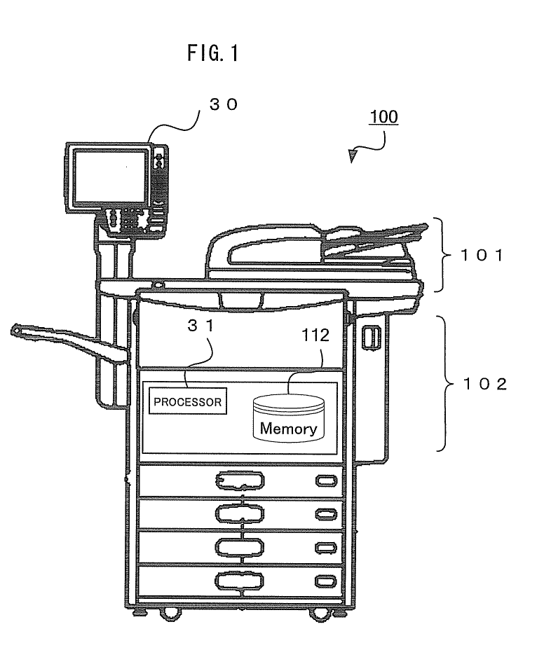

FIG. 1 is a view showing a structural example of an image processing apparatus of an embodiment. The image processing apparatus 100 is an MFP (Multifunction Peripheral) having a copy function, a printer function, a scanner function, and a transmission and reception function of FAX and E-mail. The image processing apparatus 100 includes a processor 31 as an arithmetic processing unit, and includes a memory 112 including a RAM (Random Access Memory) as a volatile storage device, a ROM (Read Only Memory) as a nonvolatile storage device and a HDD (Hard disk drive).

The image processing apparatus 100 includes a control panel unit 30 (input apparatus) that displays control content and receives instructions from a user.

Besides, the image processing apparatus 100 includes an image reading part 101 to scan and read an image of a sheet document and a book document, and an image forming part 102 to form the image read by the image reading part 101 or an image of image data received from the outside on a sheet.

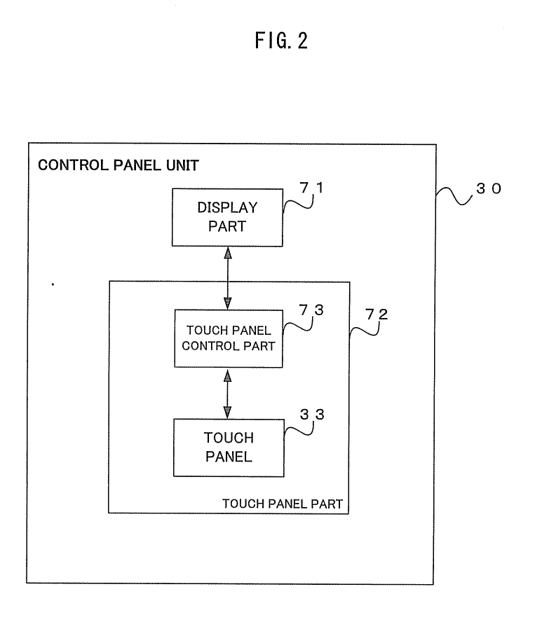

FIG. 2 shows an example of a function block of the control panel unit 30. The control panel unit 30 includes a display part 71 and a touch panel part 72. The touch panel part 72 includes a touch panel 33 and a touch panel control part 73. The display part 71 displays one or plural button images. The touch panel 33 is provided at an upper part of a display area of the display part 71. The touch panel control part 73 supplies power to the touch panel 33 so that the power is supplied only to an area which is an area of the touch panel 33 and corresponds to an area of the button image displayed on the display part 71.

With respect to the details of the control panel unit 30, an example in which a light-emitting element and a light-receiving element are used will be described in a first embodiment, and an example in which a resistive film is used will be descried in a second embodiment.

### First Embodiment

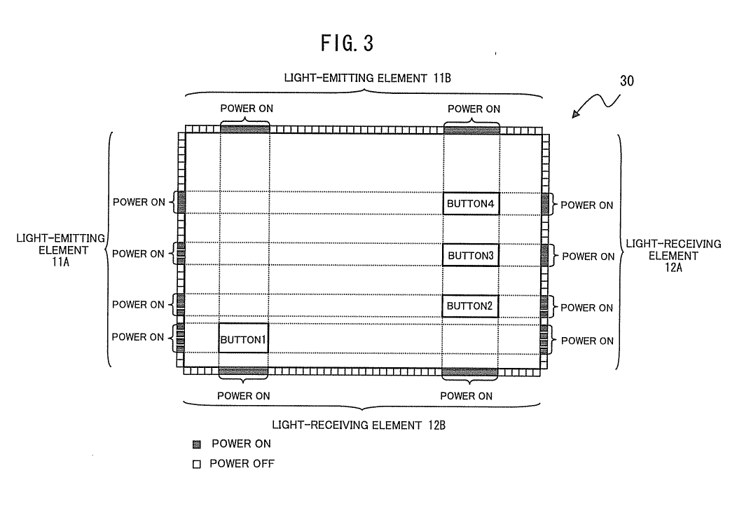

FIG. 3 is a view showing a relation between a position of an input button image displayed by the display part 71 of the control panel unit 30 and power on and off of a light-emitting element and a light-receiving element of the touch panel 33.

Buttons 1 to 4 are images of input buttons displayed on the LCD screen of the display part 71. The touch panel 33 includes light-emitting elements 11A and 11E at the left part and the upper part, and light-receiving elements 12A and 12B at the right part and the lower part.

As the position detection of the touch panel part 72, the upper light-emitting element 11B and the lower light-receiving element 12B are used for detection in a horizontal direction, and the left light-emitting element 11A and the right light-receiving element 12A are used for detection in a vertical direction. The light-receiving elements 12A and 12B receive light from the light-emitting elements 11A and 11B. The position detection is performed in such a way that the light is shielded by a finger tip of a user or a pen tip, and the light-receiving elements 12A and 12B can not receive the light of the light-emitting elements 11A and 11B.

In the light-emitting elements 11A and 11B and the light-receiving elements 12A and 12B, many light-emitting elements and light-receiving elements are used in order to detect the whole area of the LCD screen.

On the LCD screen of FIG. 3, it is sufficient to determine whether the input buttons 1 to 4 are in a selected state or a non-selected state. Thus, only the light-emitting elements 11A and 11B and the light-receiving elements 12A and 12B for detecting the states of the buttons 1 to 4 are used in the power-on state so that they become functionally effective. In FIG. 3, the light-emitting elements and the light-receiving elements indicated by black squares are in the power-on state, and the light-emitting elements and the light-receiving elements indicated by white squares are in the power-off state.

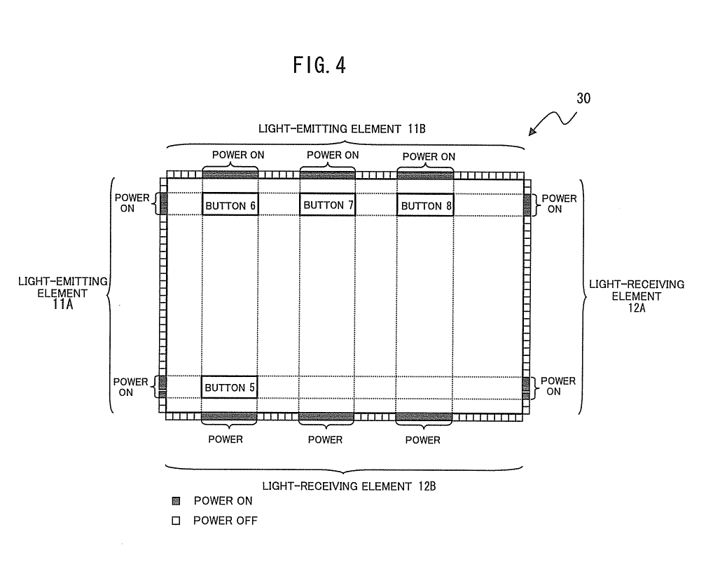

FIG. 4 is a view (example different from FIG. 3) showing a relation between a position of an input button image displayed by the display part 71 and power on and off of the light-emitting elements 11A and 11B and the light-receiving elements 12A and 123 of the touch panel 33.

In FIG. 4, although buttons 5 to 8 are displayed on the LCD screen of the display part 71 similarly to FIG. 3, the positions of the buttons are different from those in FIG. 3. According to the change of the screen display positions of the buttons, the touch panel control part 73 changes the power-on states and the power-off states of the light-emitting elements and the light-receiving elements.

The arrangement of the buttons 5 to 8 of FIG. 4 is different from the arrangement of the buttons 1 to 4 of FIG. 3 in features. At the position of the button 1 of FIG. 3, there is no portion overlapping the buttons 2 to 4 in both the vertical direction and the horizontal direction. However, at the position of the button 5 of FIG. 4, there is a portion overlapping the button 6 in the horizontal direction. Since the overlapping portion exists, the number of the light-emitting elements and the light-receiving elements for which the power is turned on can be decreased.

As compared with the buttons 2 to 4, the button 1 of FIG. 3 is long in the vertical direction and is short in the horizontal direction. The button 5 of FIG. 4 and the buttons 6 and 7 have the same length in both the vertical direction and the horizontal direction. Since the same length is adopted, the light-emitting elements and the light-receiving elements can be arranged in the overlapping positional relation in both the vertical direction and the horizontal direction, and the number of the light-emitting elements and the light-receiving elements for which the power is turned on can be decreased.

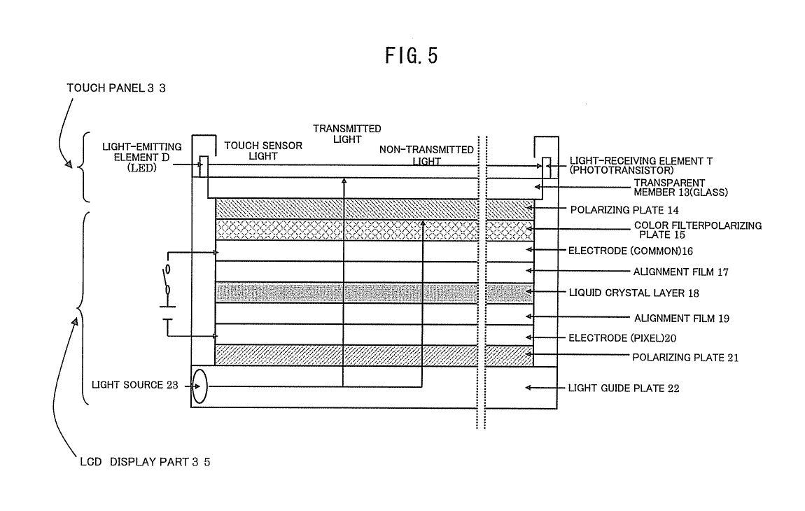

FIG. 5 is a sectional view of the touch panel 33 and an LCD display part of the display part 71 in the embodiment.

The touch panel 33 and the LCD display part 35 have an overlapping structure in the up-and-down direction, and the touch panel 33 is located at the upper part, and the LCD display part 35 is located at the lower part.

The touch panel 33 includes a transparent member 13 (glass) to allow light from the lower LCD display part 35 to pass through, a light-emitting element D (LED) as a touch detection light source, and a light-receiving element T (phototransistor) to receive light of the touch detection light source.

The light (touch sensor light) outputted from the light-emitting element D passes through an upper part of the transparent member 13 and reaches the light-receiving element T.

Next, an inner structure of the LCD display part 35 will be described. The light outputted from a light source 23 for light emission is guided toward an upper part of the LCD display part 35 by a light guide plate 22.

In the guided light, only light having a specific direction is allowed to pass through by a polarizing plate 21.

The light passing through the polarizing plate 21 passes through a transparent electrode (pixel) 20, an alignment film 19, a liquid crystal layer 18, an alignment film 17, a transparent electrode (common) 16 and a color filter polarizing plate 15, and reaches an upper polarizing plate 14.

The light reaching the polarizing plate 14 is divided into a light (transmitted light) passing through the polarizing plate 14 and a light (non-transmitted light) not passing through the polarizing plate 14, and only the transmitted light reaches the transparent member 13 and is recognized as an emitted light by the user.

The liquid crystal layer 18 is sandwiched between the alignment films 17 and 19 in the up-and-down direction, and the two alignment films 17 and 19 are arranged in the directions in which the phases are different by 90 degrees.

The liquid crystal layer 18 is in a state where liquid crystal molecules are twisted by 90 degrees in accordance with the phases of the alignment films 17 and 19. The phase of the polarizing plate 21 is equal to the phase of the alignment film 19, and the phase of the polarizing plate 14 is equal to the phase of the alignment film 17. The phase of the polarizing plate 21 and the alignment film 19 is different from the phase of the polarizing plate 14 and the alignment film 17 by 90 degrees.

The electrode (pixel) 20 exists under the alignment film 19, and the electrode (common) 16 exists on the alignment film 17. When a voltage is not applied between the electrode (pixel) 20 and the electrode (common) 16, the liquid crystal molecules are twisted by 90 degrees. Thus, when the light which passes through the polarizing plate 21 and in which the phase is uniformed passes through the liquid crystal layer 18, the light becomes the light in which the phase is twisted by 90 degrees. The light reaches the polarizing plate 14 and passes through the polarizing plate 14.

When a voltage is applied between the electrode (pixel) 20 and the electrode (common) 16, the liquid crystal molecules of the liquid crystal layer 18 are in a parallel state in which the twist of 90 degrees is returned. Thus, when the light which passes through the polarizing plate 21 and in which the phase is uniformed passes through the liquid crystal layer 18, the light having the same phase reaches the polarizing plate 14. Thus, the light different in phase from the polarizing plate 14 by 90 degrees can not pass through the polarizing plate 14.

The light (transmitted light) passing through the polarizing plate 14 is the light when the voltage is not applied between the electrode (pixel) 20 and the electrode (common) 16. On the other hand, the light (non-transmitted light) not passing through the polarizing plate 14 is the light when the voltage is applied between the electrode (pixel) 20 and the electrode (common) 16.

The electrode (pixel) 20 is controlled in position units of color filters corresponding to three primary colors of a pixel, and a potential difference occurs between the electrode (pixel) 20 and the electrode (common) 16.

The position where the potential difference occurs and the position where there is no potential difference are controlled, so that the control is performed as to whether light is allowed to pass through to the upper part of the polarizing plate 14.

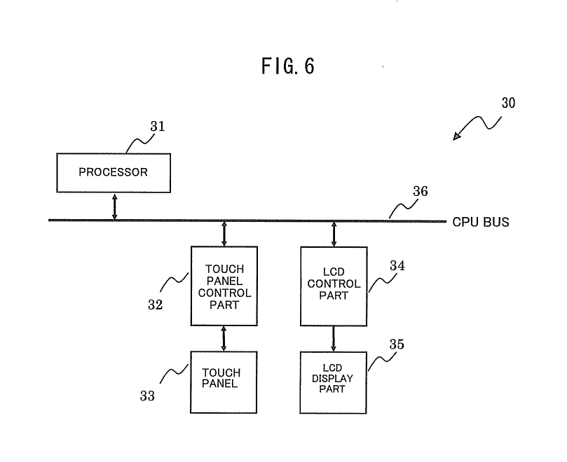

FIG. 6 is a view showing a hardware structural example of the inside of the control panel unit 30.

The control panel unit 30 includes a touch panel control circuit 32 to control the detection (hereinafter referred to as touch detection) of touch by a user's finger tip or a pen tip, and the touch panel 33, a LCD control circuit 34 to control screen display, and the LCD display part 35 to perform screen display. Besides, the control panel unit 30 includes the processor 31 shown in FIG. 1, and the processor 31 controls the touch panel control circuit 32 and the LCD control circuit 34. Incidentally, the touch panel control part 73 of FIG. 2 is realized by the touch panel control circuit 32 and the processor 31. The display part 71 is realized by the LCD control circuit 34, the LCD display part 35 and the processor 31.

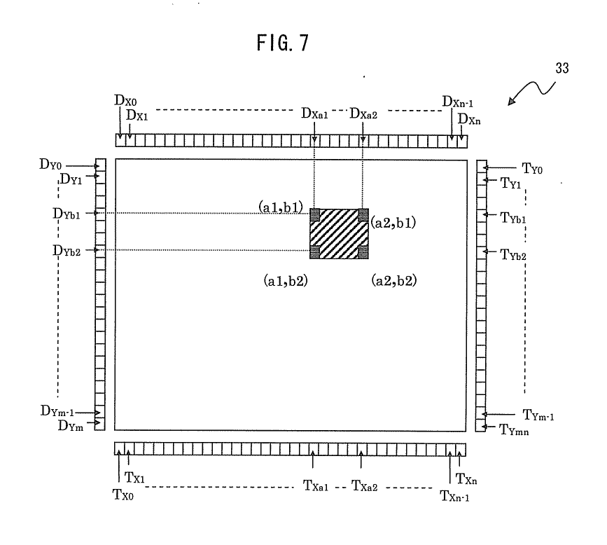

FIG. 7 is a view showing a positional relation (touch panel 33 side) between a touch detection area of the touch panel 33 and an input button displayed by the LCD display part 35.

FIG. 7 shows plural light-emitting elements (Dx0 to Dxn) and plural light-receiving elements (Tx0 to Txn) for detection in the horizontal direction of the touch panel 33. Besides, FIG. 7 shows plural light-emitting elements (DY0 to DYm) and plural light-receiving elements (TY0 to TYm) for detection in the vertical direction of the touch panel 33. A portion where the touch detection can be performed is a rectangular area defined by connecting four points of (Dx0, DY0), (Dxn, DY0), (Dx0, DYm) and (Dxn, DYm).

A rectangular area defined by connecting (Dxa1, Dxb1), (Dxa2, DYb1), (Dxa1, DYb2) and (Dxa2, DYb2) in the area of FIG. 7 where the touch detection can be performed is a portion where the touch detection can be performed as an input button on the control panel screen.

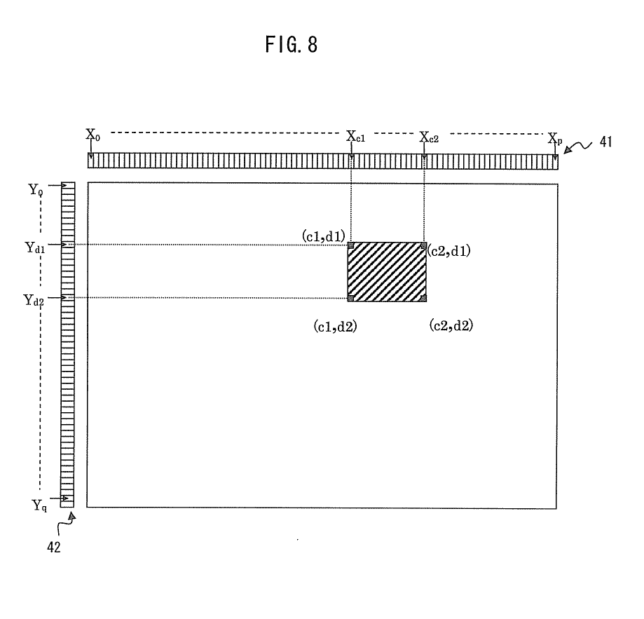

FIG. 8 shows a positional relation (LCD display part 35 side) between a touch detection area of the touch panel 33 and an input button displayed by the LCD display part 35.

Drive circuits 41 (X0 to Xp) to control display in the horizontal direction and drive circuits 42 (Y0 to Yq) to control display in the vertical direction are provided.

An intersection point in the vertical and horizontal directions is a display control object, and the drive circuits 41 and the drive circuits 42 change and control the display control object in time division. A rectangular area defined by connecting four points of (X0, Y0), (Xp, Y0), (X0, Yq) and (Xp, Yq) becomes a displayable area. A rectangular area defined by connecting (Xc1, Yd1), (Xc2, Yd1), (Xc1, Yd2) and (Xc2, Yd2) in the displayable area of FIG. 8 is a portion displayed as an input button on the screen of the control panel unit 30.

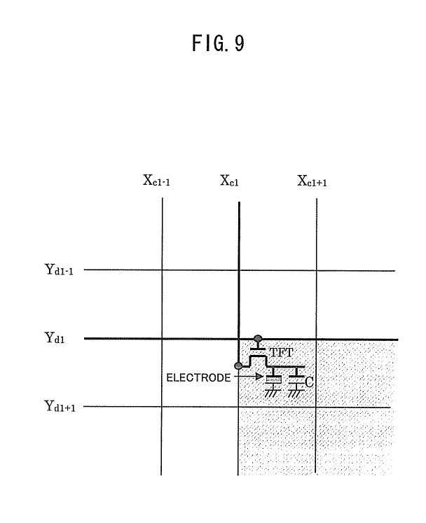

FIG. 9 is a view showing a drive system of the LCD display part 35, and is a view showing a state where a voltage is applied to an intersection point (Xc1, Yd1) from the horizontal direction and the vertical direction in a TFT (Thin Film Transistor) active matrix system (TFT Active matrix). A TFT functions as a switch and applies a voltage to an intersection point.

Liquid crystal (the liquid crystal layer 18 of FIG. 5) exists in an area sandwiched between an electrode and a common electrode (GND) of FIG. 9, and the voltage is applied. A voltage application time is determined by a time from the voltage application to a capacitor (C) to the discharge in a non-connection state. The next voltage is applied before the voltage is reduced, so that the voltage application state is maintained.

Since the resolution of the touch detection is different from the resolution of the LCD display part, in order to perform the touch detection and the LCD display in the same area, it is necessary to maintain a relation of

a2−a1=(c2−c1)×(n+1)/(p+1)

b2−b1=(d2−d1)×(m+1)/(q+1)

(with respect to the respective variables of the above expressions, see FIG. 7 and FIG. 8).

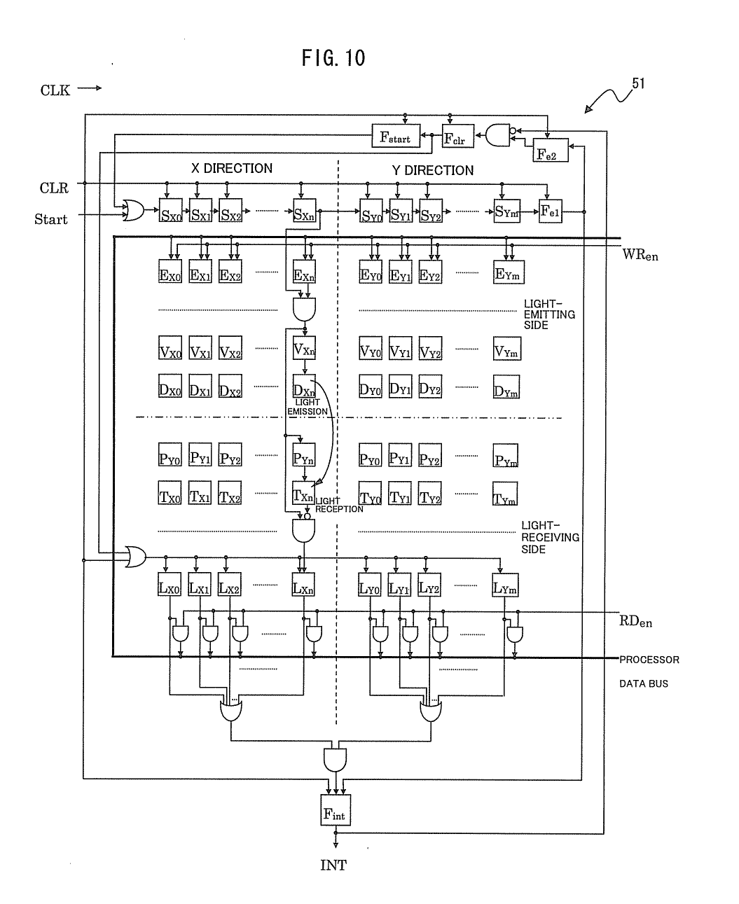

FIG. 10 shows a touch detection drive circuit of the touch panel control circuit 32.

The touch detection drive circuit 51 includes touch detection position shift registers (Sx0 to Sxn, SY0 to SYm) to generate a timing when a combination of a light-emitting element D and a light-receiving element T is driven in sequence, and touch detection area registers (Ex0 to Exn, EY0 to EYm) to determine an area of a light-emitting element and a light-receiving element in which the touch detection is performed. Besides, the touch detection drive circuit 51 includes light-emitting element drive circuits (Vx0 to Vxn, VY0 to VYm) to control whether a voltage is applied to a light-emitting element D to emit light or a voltage is not applied not to emit light, and light-emitting elements (Dx0 to Dxn, DY0 to DYm). The touch detection drive circuit 51 includes light-receiving element power supply control circuits (Px0 to Pxn, PY0 to PYm) to control power supply to each light-receiving element T, and light-receiving elements (Tx0 to Txn, TY0 to TYm). The touch detection drive circuit 51 includes touch detection position information registers (Lx0 to Lxn, LY0 to LYm) to hold position information of touch detection, and a touch detection interrupt register (Fint) to generate an interrupt at the time of touch detection. The touch detection drive circuit 51 outputs a touch detection interrupt signal (INT) to the processor 31.

Besides, the touch detection drive circuit 51 includes timing registers (Fe1, Fe2) to generate an end timing of touch detection in the vertical direction after the touch detection in the horizontal direction is performed, and a clear register (Fclr) to generate a clear signal of the control circuit after the touch detection in the vertical direction is ended after the touch detection in the horizontal direction is performed. The touch detection drive circuit 51 includes a restart register (Fstart) to restart the touch detection in the vertical direction and the horizontal direction after the touch detection in the vertical direction is ended after the touch detection in the horizontal direction is performed. The touch detection drive circuit receives a clear signal (CLR) to clear the respective registers from the processor 31.

Besides, the touch detection drive circuit 51 receives a touch detection start signal (Start), which is a signal for starting the touch detection and is generated at the writing timing of the processor 31, from the processor 31.

The touch detection drive circuit 51 writes area data outputted from the processor 31 into the touch detection area registers (Ex0 to Exn, EY0 to EYm) at the timing of a touch detection area data writing signal (WRen).

The touch detection area data writing signal (WRen) is a signal generated (a generation circuit is not shown) from a writing signal (not shown) outputted from the processor 31, and is a signal by which the processor 31 writes data into the touch detection area registers (Ex0 to Exn, EY0 to EYm).

The touch detection drive circuit 51 outputs the data of the touch detection position information registers (Lx0 to Lxn, LY0 to LYm) to the processor 31 at the timing of a touch detection position information read signal (RDen).

The touch detection position information read signal (RDen) is a signal generated (a generating circuit is not shown) from a read signal (not shown) outputted from the processor 31, and is a signal by which the processor 31 reads data from the touch detection position information registers (Lx0 to Lxn, LY0 to LYm).

The touch detection drive circuit 51 operates in synchronization with a touch detection drive circuit basic clock (CLK) for operating the touch detection drive circuit of the touch panel.

The start timing of the touch detection is the time when the touch detection start signal (Start) outputted by the processor 31 is in a state of “1” (the Start signal is in the state of “1” only for 1 clk period).

When the Start signal of “1” is inputted to the touch detection position shift register (Sx0), the output state of “1” is shifted in sequence of Sx0, Sx1, Sx2, . . . , Sxn, SY0, SY1, SY2, . . . , SYm) at each clock of the touch detection drive circuit basic clock (CLK).

The light-emitting element drive circuits (Vx0 to Vxn, VY0 to VYm) drive the light-emitting elements D (Dx0 to Dxn, DY0 to DYm) to output light at the timing when the output states of the touch detection position shift registers (Sx0 to Sxn, SY0 to SYm) are “1”, and the outputs of the touch detection area registers (Ex0 to Exn, EY0 to EYm) are “1”.

At the same timing, the power is supplied to the respective light-receiving elements T from the light-receiving element power supply control circuits (Px0 to Pxn, PY0 to PYm).

When the touch panel 33 is not in the touch state, the light outputted from the light-emitting element D is inputted to the light-receiving element T (Tx0 to Txn, TY0 to TYm), and “1” indicating the light reception state is outputted.

When the touch panel 33 is in the touch state, since the light outputted from the light-emitting element D (Dx0 to Dxn, DY0 to DYm) is not inputted to the light-receiving element T (Tx0 to Txn, TY0 to TYm), the light-receiving element T outputs “0” indicating the light non-reception state.

When the light-receiving element T is in the light non-reception state “0” at the timing when the output of the touch detection area register (Ex0 to Exn, EY0 to EYm) is “1” (state where the light outputted from the light-emitting element is not inputted to the light-receiving element by a light shielding member, that is, the touch panel is in the touch state), the touch detection position information register (Lx0 to Lxn, LY0 to LYm) causes the value of the corresponding register to become “1” at the next CLK timing and holds it. The held state is held until the start of next touch detection.

When the touch detection in the horizontal direction (transition in sequence of Sx0, Sx1, Sx2, . . . , Sxn) and the touch detection in the vertical direction (transition in sequence of SY0, SY1, SY2, . . . , SYm) are ended, the timing register (Fe1) becomes “1”. When at least one of the touch detection position information registers (Lx0 to Lxn) is in the “1” state, and at least one of the touch detection position information registers (LY0 to LYm) is in the “1” state, “1” is held in the touch detection interrupt register (Fint). The touch detection interrupt register (Fint) maintains “1” unless the clear signal (CLR) is inputted.

When “1” is held in the touch detection interrupt register (Fint), the touch detection drive circuit 51 outputs the touch detection interrupt signal (INT)=“1” to the processor 31, and an interrupt occurs in the processor 31.

The processor 31 reads the touch detection position information registers (Lx0 to Lxn, LY0 to LYm) in the touch detection interrupt process, and specifies the touch position.

The processor 31 generates the clear signal (CLR) in the touch detection interrupt process and releases the interrupt (touch detection interrupt signal (INT)=“0”).

After the touch detection interrupt process is ended, the processor 31 outputs the touch detection start signal (Start) of “1” in order to restart the next touch detection.

On the other hand, when the touch detection in the horizontal direction (transition in sequence of Sx0, Sx1, Sx2, . . . , Sxn) and the touch detection in the vertical direction (transition in sequence of SY0, SY1, SY2, . . . , SYm) are ended, the timing register (Fe1) becomes “1”. At this time, when there is no register of the state of “1” in the touch detection position information registers (Lx0 to Lxn) and there is no register of the state of “1” in the touch detection position information registers (LY0 to LYm) (state where there is no touch), or when there is no register of the state of “1” in the touch detection position information registers (Lx0 to Lxn) or there is no register of the state of “1” in the touch detection position information registers (LY0 to LYm) (in the case of touch erroneous detection), “0” is held in the touch detection interrupt register (Fint) (touch detection interrupt does not occur: the touch detection interrupt signal (INT)=“0” is outputted).

When the touch detection interrupt signal (INT) is “0”, the timing register 1 (Fe2) becomes “1” at the next CLK, the clear register (Fclr) becomes “1” at the next CLK, and the respective registers are cleared at the next CLK. The touch detection start signal (Start) becomes “1” at the timing when the respective registers are cleared, and the touch detection in the horizontal direction and the vertical direction is started at the next CLK.

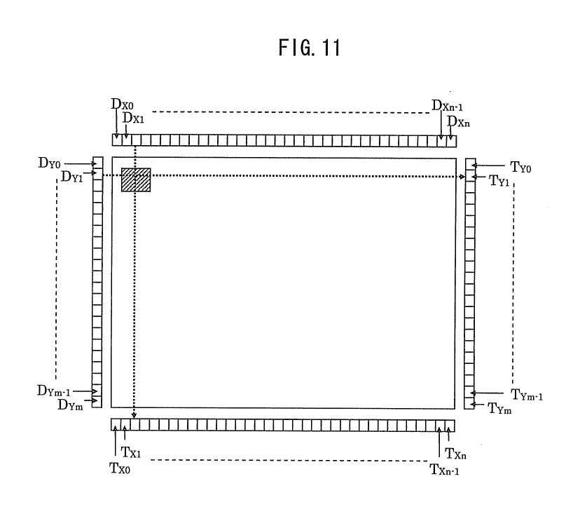

FIG. 11 is a view showing a positional relation between a touch detection area of the touch panel 33 and an input button of the LCD display part 35.

The area of the input button of the LCD display part 35 is a position corresponding to the touch detection area ((x1, Y1) to (x3, Y2)) of the touch panel 33. The light-emitting elements (Dx1 to Dx3) and the light-receiving elements (Tx1 to Tx3) in the horizontal direction, and the light-emitting elements (DY1 to DY2) and the light-receiving elements (TY1 to TY2) in the vertical direction are used in the touch detection of the input button.

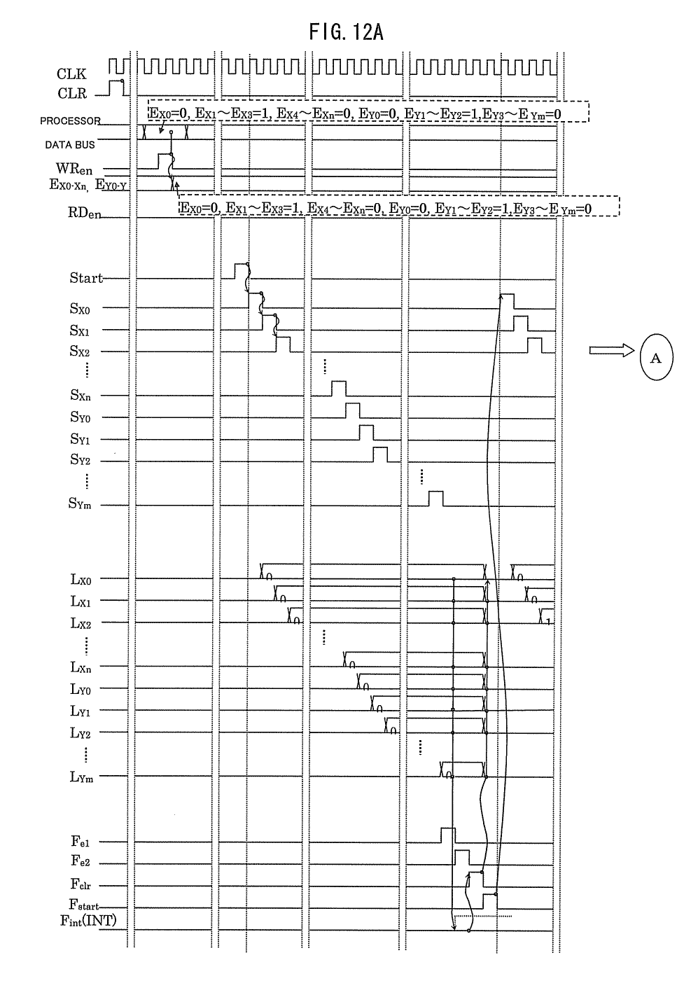

FIG. 12A and FIG. 12B are timing charts of the touch detection drive circuit 51. FIG. 12A and FIG. 12B show timing when the touch detection drive circuit 51 of FIG. 10 performs the touch detection of the input button of FIG. 11.

The processor 31 generates a clear signal (CLR) and brings the touch detection drive circuit 51 into the initial state. The clear signal (CLR) is generated by a circuit not shown in FIG. 10, and becomes the signal of the “1” state for 1 CLK time, which is synchronous with the touch detection drive circuit basic clock (CLK) from the writing instruction of the processor 31.

The processor 31 sets touch detection effectiveness (“1”) or touch detection ineffectiveness (“0”) to the initialized touch detection are registers ((Ex0 to Exn, EY0 to EYm)=“0”) in accordance with the touch detection area. In this example, the X direction: EX0=0, EX1 to EX3=1, EX4 to EXn=0, Y direction: EY0=0, EY1 to EY2=1, EY3 to EYm=0 are established.

The processor 31 generates the touch detection start signal (Start) and starts the touch detection. The touch detection start signal (Start) is generated by a circuit not shown in FIG. 10, and becomes the signal of the “1” state for 1 CLK time, which is synchronous with the touch detection drive circuit basic clock (CLK) from the writing instruction of the processor 31.

By the touch detection start signal (Start), the touch detection position shift register transits to the “1” state in units of 1 CLK time (transition in sequence of Sx0, Sx1, Sx2, . . . , Sxn, SY0, SY1, SY2, . . . , SYm).

The light-emitting element D emits light at the timing when the touch detection area register is “1” and the touch detection position shift register is “1”. When receiving the light, the light-receiving element T outputs “1”.

At the same timing, the light-receiving state or non-detection state=“0”, the light non-reception state=“1” is inputted to the inputs of the touch detection position information registers (Lx0 to Lxn, LY0 to LYm). After 1 CLK, the input state is held in the touch detection position information registers (Lx0 to Lxn, LY0 to LYm).

Since there is no touch state in the first touch detection, “0” is held in all outputs of the touch detection position information registers (Lx0 to Lxn, LY0 to LYm).

When all the outputs of the touch detection position information registers (Lx0 to Lxn) are in the state of “0”, or all the outputs of the touch detection position information registers (LY0 to LYm) are in the state of “0”, the timing register (Fe1) is “1”, and “0” is held in the touch detection interrupt register (Fint) at the rising timing of the touch detection drive circuit basic clock (CLK). Thus, the touch detection interrupt does not occur in the processor 31.

When the touch detection interrupt does not occur in the processor 31, the timing register (Fe2) is “1”. The clear register (Fclr)=“1” is outputted for 1 CLK time at the rising timing of the touch detection drive circuit basic clock (CLK), and the outputs of the touch detection position information registers (Lx0 to Lxn, LY0 to LYm) are cleared. When 1 CLK passes after the outputs of the touch detection position information registers (Lx0 to Lxn, LY0 to LYm) are cleared, the output of the restart register (Fstart) becomes “1”, and the touch detection is again started.

Since there is a touch state in the second touch detection, “1” is held in the output of the touch detection position information register (Lx2, LY1). When the OR output of the touch detection position information registers (Lx0 to Lxn) is “1”, and the OR output of the touch detection position information registers (LY0 to LYm) is “1”, the timing register (Fe1) is 1, and “1” is held in the touch detection interrupt register (Fint) at the rising timing of the touch detection drive circuit basic clock (CLK). Thus, the touch detection interrupt occurs in the processor 31. While “1” is held in the touch detection interrupt register (Fint), “0” is held in the outputs of both the clear register (Fclr) and the restart register (Fstart). Thus, the touch detection becomes the stop state.

In the touch detection interrupt process, the processor 31 reads the values of the touch detection position information registers (Lx0 to Lxn, LY0 to LYm) at the timing of the touch position information read signal (RDen)=1.

In the touch detection interrupt process, the processor 31 generates the clear signal (CLR), and brings the touch detection drive circuit 51 into the initial state. At the time of the initialization, the touch detection interrupt register (Fint) becomes the state of “0”, and the touch detection interrupt process is ended. After the touch detection interrupt process is ended, the processor 31 generates the touch detection start signal (Start)=“1”, and again starts the touch detection.

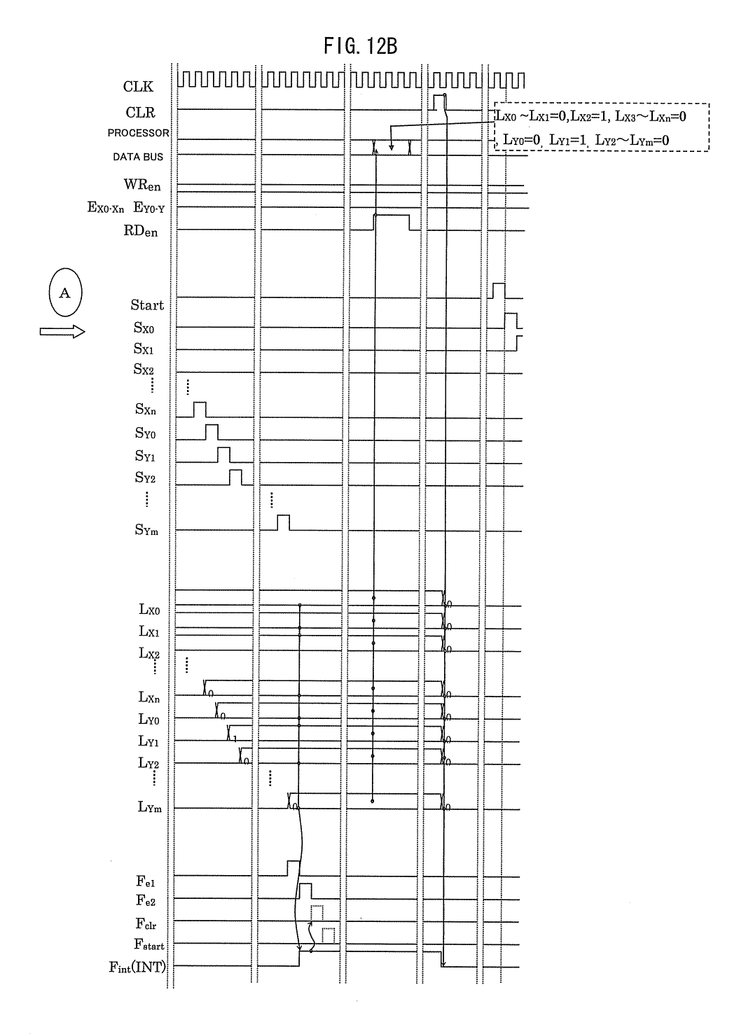

FIG. 13 shows the light-emitting element D (Dx0 to Dxn, DY0 to DYm), the light-emitting element drive circuit (Vx0 to Vxn, VY0 to VYm), the light-receiving element T (Tx0 to Txn, TY0 to TYm), and the light-receiving element power supply control circuit (Px0 to Pxn, PY0 to PYm).

When the input of the light-emitting element drive circuit (Vx0 to Vxn, VY0 to VYm) is “1”, the ON state occurs between C-E of a transistor (Q2), the power voltage VCC is applied and the light-emitting element D (Dx0 to Dxn, DY0 to DYm) emits light (light-emitting state). When the input is “0”, the off state occurs between C-E of the transistor (Q2), and the power voltage VCC is not applied. Thus, the light-emitting element D (Dx0 to Dxn, DY0 to DYm) does not emit light (non-light-emitting state).

The light-emitting element D (Dx0 to Dxn, DY0 to DYm) emits light (light-emitting state) when the power voltage VCC from the light-emitting element drive circuit (Vx0 to Vxn, VY0 to VYm) is applied. The light-emitting element D does not emit light (non-light-emitting state) when the power voltage VCC from the light-emitting element drive circuit (Vx0 to Vxn, VY0 to VYm) is not applied.

In the light-receiving element power supply control circuit (Px0 to Pxn, PY0 to PYm) to control the power supply to the light-receiving element T (Tx0 to Txn, TY0 to TYm), when the input is “1”, the ON state occurs between S-D of a FET (Q3), and the power voltage VCC is supplied to the light-receiving element T (Tx0 to Txn, TY0 to TYm) (VCC supply state). When the input is “0”, the off state occurs between S-D of the FET (Q3), and the power voltage VCC is not supplied to the light-receiving element T (Tx0 to Txn, TY0 to TYm) (VCC non-supply state).

When receiving the light from the light-emitting element D (Dx0 to Dxn, DY0 to DYm) in the state (VCC supply state) where the power voltage VCC is supplied from the light-receiving element power supply control circuit (Px0 to Pxn, PY0 to PYm), the light-receiving element T (Tx0 to Txn, TY0 to TYm) outputs “1”. When not receiving the light from the light-emitting element D (Dx0 to Dxn, DY0 to DYm), the light-receiving element T (Tx0 to Txn, TY0 to TYm) outputs “0”. In the state (VCC non-supply state) where the power voltage VCC is not supplied from the light-receiving element power supply control circuit (Px0 to Pxn, PY0 to PYm), the light-receiving element T (Tx0 to Txn, TY0 to TYm) outputs “0”.

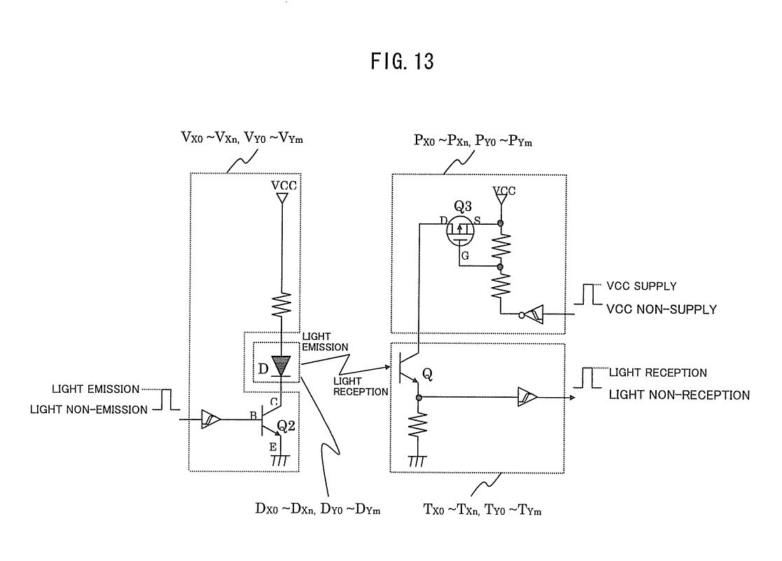

FIG. 14 is a view showing a timing chart (EX0 to EXn=1, EY0 to EYm=1) representing the light-emitting states of the light-emitting elements D (Dx0 to Dxn, DY0 to DYm) and the power supply states to the light-receiving elements T (Tx0 to Txn, TY0 to TYm). FIG. 14 shows the timing of the light-emitting elements D (Dx0 to Dxn, DY0 to DYm) and the light-receiving element power supply control circuits (Px0 to Pxn, PY0 to PYm) when the touch detection is performed twice in the case where the values of the touch detection area registers (Ex0 to Exn, EY0 to EYm) are set to Ex0 to Exn=1 and EY0 to EYm=1.

All the light-emitting elements D (Dx0 to Dxn, DY0 to DYm) become the light-emitting states in sequence one by one. The light-receiving element power supply control circuits (Px0 to Pxn, PY0 to PYm) corresponding to the light-emitting elements D (Dx0 to Dxn, DY0 to DYm) also become the power VCC supply states in sequence one by one.

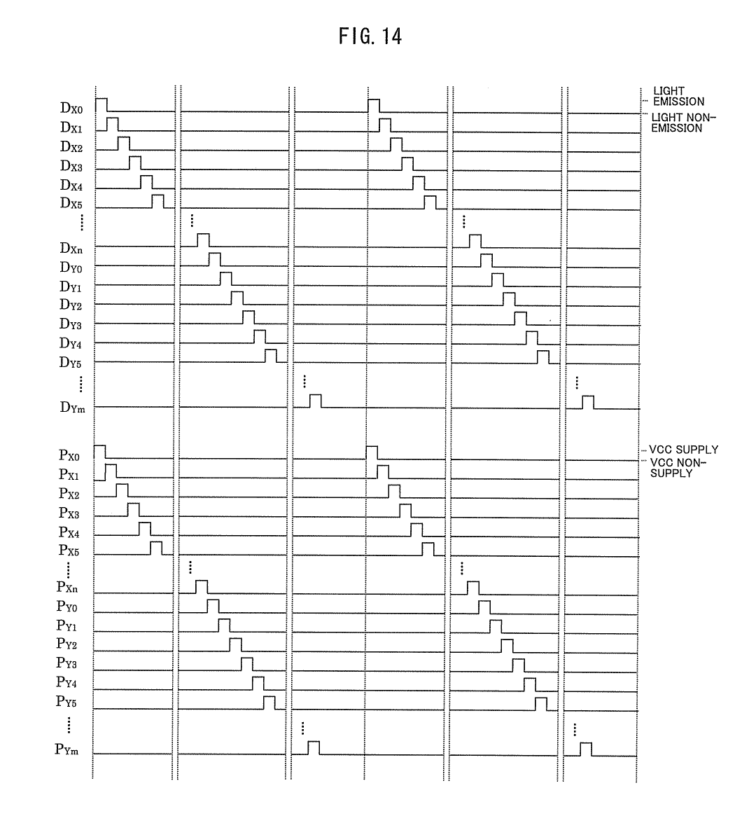

FIG. 15 is a view showing a timing chart (EX0=0, EX1 to EX3=1, EX4 to Exn=0, EY0=0, EY1 to EY2=1, EY3 to EYm=0) representing light-emitting states of the light-emitting elements D (Dx0 to Dxn, DY0 to DYm) and power supply states to the light-receiving elements T (Tx0 to Txn, TY0 to TYm). FIG. 15 shows the timing of the light-emitting elements D (Dx0 to Dxn, DY0 to DYm) and the light-receiving element power supply control circuits (Px0 to Pxn, PY0 to PYm) when the touch detection is performed twice in the case where the values of the touch detection area registers (Ex0 to Exn, EY0 to EYm) are set to EX0=0, EX1 to EX3=1, EX4 to EXn=0, EY0=0, EY1 to EY2=1, and EY3 to EYm=0. Besides, FIG. 15 shows the timing (see FIG. 11) of the case where the touch detection area is ((x1,Y1) to (x3,Y2)).

The light-emitting element D (Dx0) is always in the non-light-emitting state. The light-emitting elements D (Dx1 to Dx3) become the light-emitting state in sequence one by one.

The light-emitting elements D (Dx4 to Dxn) are always in the non-light-emitting state. The light-emitting element D (DY0) is always in the non-light-emitting state. The light-emitting elements D (DY1 to DY2) become the light-emitting state in sequence one by one. The light-emitting elements D (DY3 to DYm) are always in the non-light-emitting state.

The light-receiving element power supply control circuit (Px0) corresponding to the light-emitting element D (Dx0) is always in the power VCC non-supply state. The light-receiving element power supply control circuits (Px1 to Px3) corresponding to the light-emitting elements D (Dx1 to Dx3) become the power VCC supply state in sequence one by one. The light-receiving element power supply control circuits (Px4 to Pxn) corresponding to the light-emitting elements D (Dx4 to Dxn) are always in the power VCC non-supply state.

The light-receiving element power supply control circuit (PY0) corresponding to the light-emitting element D (DY0) is always in the power VCC non-supply state. The light-receiving element power supply control circuits (PY1 to PY2) corresponding to the light-emitting elements D (DY1 to DY2) become the power VCC supply state in sequence one by one. The light-receiving element power supply control circuits (PY3 to PYm) corresponding to the light-emitting elements D (DY3 to DYm) are always in the power VCC non-supply state.

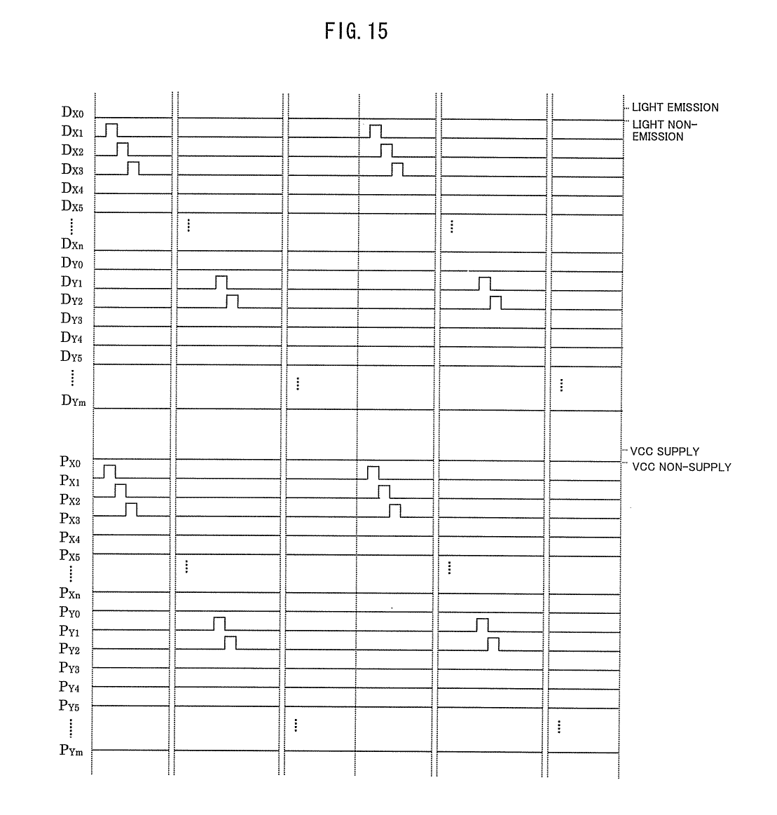

FIG. 16 is a view showing a flowchart of touch detection and screen display change control.

After the initial screen is displayed by the LCD display part 35 (ACT 1), the processor 31 clears (CLR) the touch detection drive circuit (ACT 2).

The processor 31 sets a touch detection area corresponding to an input button on the initial screen (Ex0 to Exn, EY0 to EYm) (ACT 3).

The processor 31 enables the touch detection interrupt (INT) and this enables the processor 31 to receive the interrupt (since the interrupt enable is set by the register on the processor 31 side, it is not shown in FIG. 10) (ACT 4).

The processor 31 starts the touch detection (Start) (ACT 5).

The processor 31 is placed in a state for waiting for the occurrence of the touch detection interrupt (INT) (ACT 6, loop of N).

When the touch detection interrupt (INT) occurs (ACT 6, Y), the processor 31 starts the touch detection interrupt process.

In the touch detection interrupt process, the processor 31 disables the touch detection interrupt (INT) (ACT 7).

The processor 31 reads the touch detection position in the touch detection interrupt process (the processor 31 reads the touch detection position information registers (Lx0 to Lxn, LY0 to LYm)) (ACT 8).

The processor 31 specifies a touched input button from the touch detection position information, and changes the LCD display part 35 to the screen according to the input button (ACT 9).

The processor 31 sets the touch detection area according to the input button on the new display screen (ACT 10). Since the touch detection in the touch detection area registers (Ex0 to Exn, EY0 to EYm) is suspended at the time of occurrence of the touch detection interrupt, the processor 31 clears the touch detection drive circuit 51 and enables the touch detection to be reopened (ACT 11).

The processor 31 enables the touch detection interrupt (INT) (ACT 12), and restarts the touch detection (Start) (ACT 13).

The processor 31 is placed in the state for waiting for the touch detection interrupt (INT) (returns to ACT 6).

### Second Embodiment

In the first embodiment, the description is made on the method in which the user's button depression is detected by detecting cutoff of light by using the system in which the power of only the light-emitting element and the light-receiving element corresponding to the position of the button image is turned ON. In a second embodiment, a description will be made on a method in which the user's depression is detected by using a resistive touch panel.

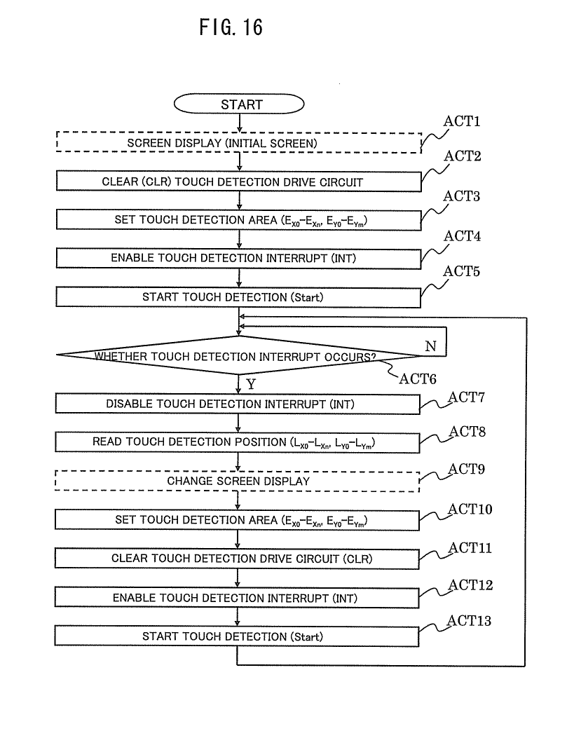

FIG. 17 is a view showing vertical direction position detection of a 4-wire resistive touch panel. Electrodes are provided on an upper end and a lower end of a lower conductive layer, and a voltage (E(V) in FIG. 17) is applied. Besides, electrodes are provided on a left end and a right end of an upper conductive layer and are uses as one electrode. The upper conductive layer and the lower conductive layer contact each other at a position “a” touched by the user, and a voltage obtained by dividing the applied voltage (E(V)) between the electrodes of the lower layer according to the distance is detected from the electrode of the upper conductive layer. In the example of FIG. 17, when the position of the touch position “a” has the distance relation of n1 to n2 in the vertical direction, the detected voltage is (n1÷(n1+n2))×E(V).

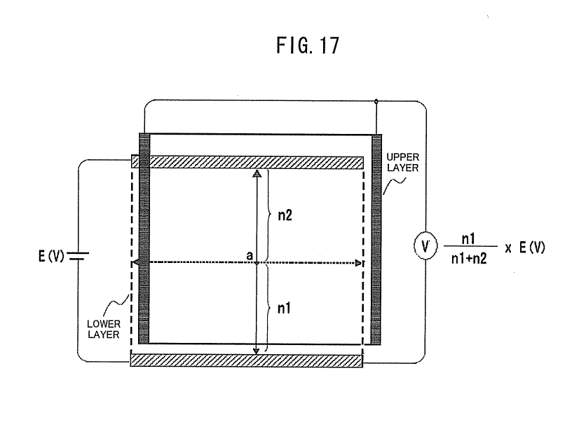

FIG. 18 is a view showing horizontal direction position detection of the 4-wire resistive touch panel. Electrodes are provided on a left end and a right end of an upper conductive layer, and a voltage (E(V) in FIG. 18) is applied. Besides, electrodes are provided at an upper end and a lower end of a lower conductive layer and are used as one electrode. The upper conductive layer and the lower conductive layer contact each other at a position “a” touched by the user, and a voltage obtained by dividing the applied voltage (E(V)) between the electrodes of the upper layer according to the distance is detected from the electrode of the lower conductive layer. In the example of FIG. 18, when the position of the touch position “a” has the distance relation of m1 to m2 in the horizontal direction, the detected voltage is (m1÷(m1+m2))×E(V).

In the 4-wire resistive touch panel, the touch position “a” is detected by the method described in FIG. 17 and FIG. 18. The position in the vertical direction is detected by the method of FIG. 17, and then, the position in the horizontal direction is detected by the method of FIG. 18. The application of the voltage shown in FIG. 17 and the application of the voltage shown in FIG. 18 are repeatedly changed several hundred times per second, so that the touch position is detected.

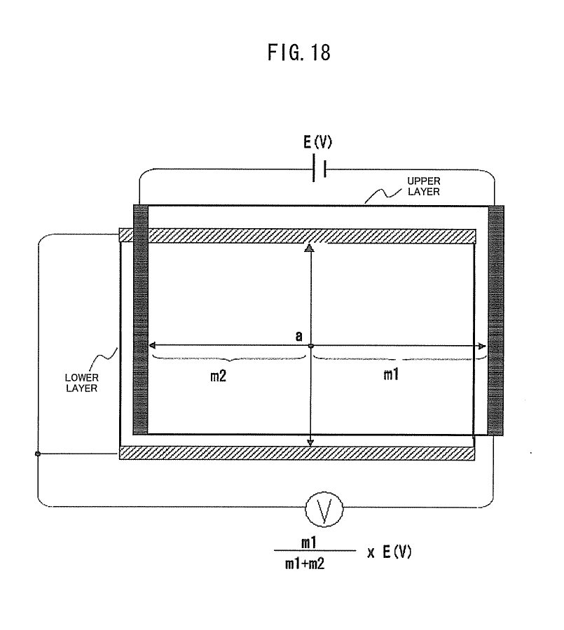

FIG. 19 is a view showing a touch detection flowchart of the 4-wire resistive touch panel. The vertical direction detection process (ACT 21) explained in FIG. 17 and the horizontal direction detection process (ACT 22) explained in FIG. 18 are repeatedly performed several hundred times per second (ACT 23, loop of “NO”). When the touch detection occurs (ACT 23, AYES″), the touch process (system process from the detection position) is performed (ACT 24). This process is repeatedly performed (return to ACT 21).

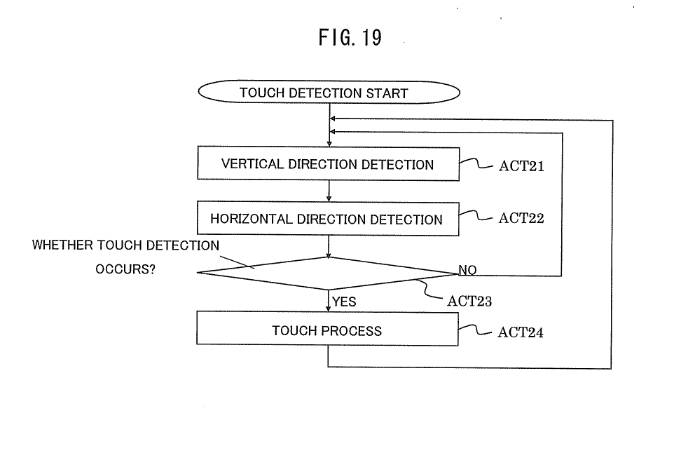

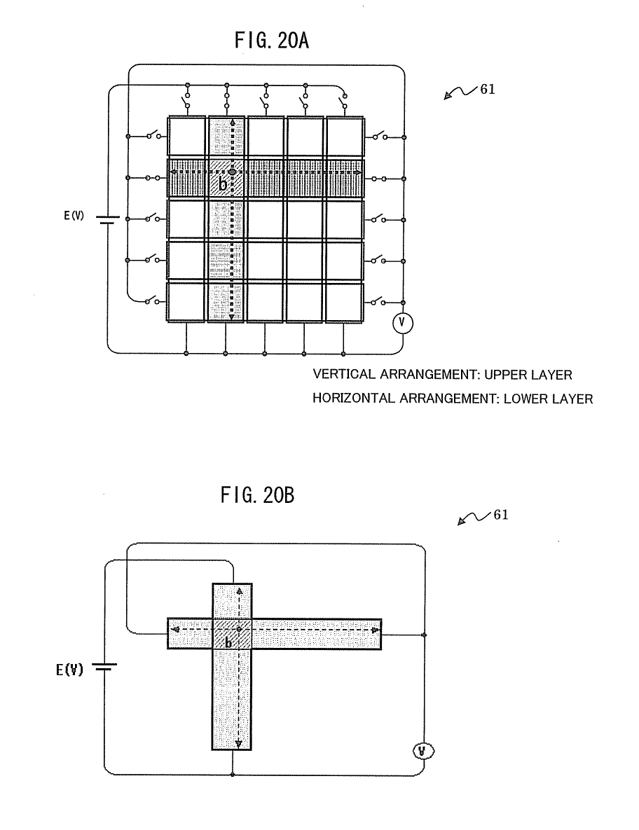

FIGS. 20A and 20B are views for explaining a touch detection method of a multi-touch system in a 4-wire resistive touch panel in a touch panel part 72 of the second embodiment. FIG. 20A is a view showing the touch detection method (vertical direction detection in screen portion detection) in the multi-touch system of the 4-wire resistive touch panel in the touch panel part 72 of the second embodiment.

The 4-wire resistive touch panel 61 is divided into a 5×5 matrix form, and the touch detection is performed in units of each area. A conductive layer to which voltage is applied and an area where the voltage is detected are changed for the five rectangular lower conductive layers and the five rectangular upper conductive layers, so that a detected area is determined, and the detailed position detection of the touch position in the area is performed.

In the 4-wire resistive touch panel 61, the ON and OFF operation (ON and OFF operation of each switch shown in FIG. 20A) is performed so that the detection is performed only in the area where each of 5×5=25 divided areas overlaps the area of the button image, and the voltage application is changed between the upper layer and the lower layer several hundred times per second, so that the touch detection in each area is performed.

Here, a description will be made on the detection in the vertical direction when a position “b” of FIG. 20A is the user's depression position. In the 4-wire resistive touch panel 61, the voltage (E(V)) is applied only to a rectangular conductive layer located second from the left of the lower conductive layer, and the voltage of the touch position is detected from a rectangular conductive layer located second from the upper conductive layer, so that the position in the vertical direction at the touch position “b” is detected.

FIG. 20B shows only a part of the 4-wire resistive touch panel 61 shown in FIG. 20A. In FIG. 20B, the conductive layers used for the detection are extracted and shown in order to facilitate the understanding of the vertical direction position detection of the touch position “b” explained in FIG. 20A.

Incidentally, although the detection in the vertical direction is explained here, the detection in the horizontal direction can also be performed by taking the explanation in FIG. 17 and FIG. 18 into account.

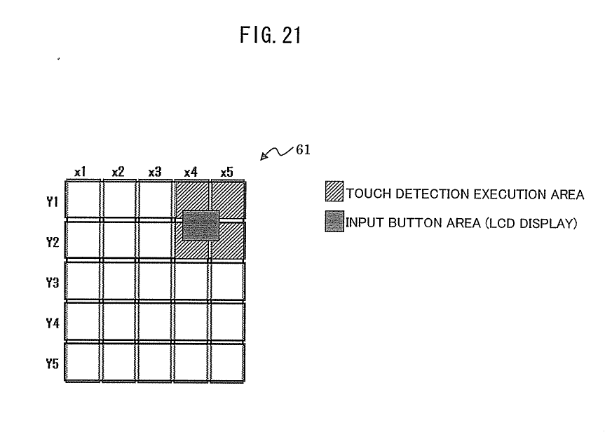

FIG. 21 is a view showing a touch detection method of an input button area in the multi-touch system of the 4-wire resistive touch panel 61. An object area is changed in sequence of (x1, Y1), (x2, Y1), (x3, Y1), (x4, Y1), (x5, Y1), (x1, Y2), . . . , (x4, Y5) and (x5, Y5) of the touch detection area by the changing control of the switch shown in FIG. 20A, and the touch detection is performed. In the example of FIG. 21, voltage application to the resist film and voltage detection are performed only when the areas of (x4, Y1), (x5, Y1), (x4, Y2) and (x5, Y2) where the input button exists are touch detected. When another area is touched, the voltage application to the resist film and the voltage detection are not performed.

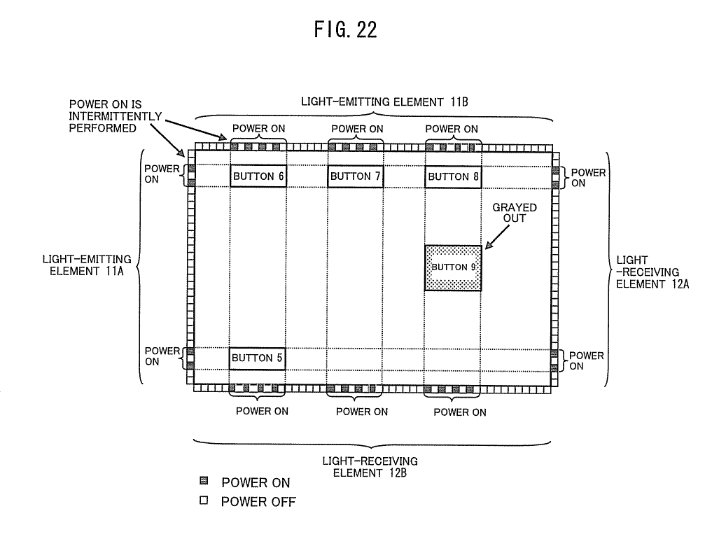

In the above respective embodiments, the technique described above can be applied also to a button which is grayed out (display state in which although the display is faintly visible, the depressing operation is not acceptable), for example, when there is no depression right to a specific button, or when a button becomes depressible by performing a specific operation. For example, like a button 9 shown in FIG. 22, for a grayed out area, the touch panel control part 73 controls so that both the light-emitting element D and the light-receiving element T are placed in the power-off state (see the light-emitting element D and the light-receiving element T for the button 9 in the horizontal direction), and the power-on state occurs when the button 9 becomes the effective state (depressible state).

It is conceivable that all power sources of the light-emitting elements and the light-receiving elements corresponding to the area of the button image are not turned on, but only part of the power sources are turned on. FIG. 22 shows a state where the power source is turned on for every other elements. Similarly, it is conceivable that the power source is turned on for every two or three light-emitting elements and light-receiving elements according to the button size. Besides, it is conceivable that the light-emitting elements and the light-receiving elements at the ends of the button are turned off, and the power source is turned on only for the center part of the button.

Incidentally, the button includes an image, such as an icon, which can be selected by the user. Besides, in the above respective embodiments, an ASIC (Application Specific Integrated Circuit) may be mounted. Besides, the processor 31 may load a program previously stored in a nonvolatile storage area of the memory 112 into a volatile storage area of the memory 112, and may perform arithmetic operation.

As described above in detail, according to the technique described herein, power is supplied only to a necessary portion of an input button image in the touch panel, and power is not supplied to an unnecessary portion. By adopting the structure as stated above, the power used in the touch panel can be reduced.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An input apparatus comprising:
a display part to display one or a plurality of button images;
a touch panel arranged at an upper part of a display area of the display part; and
a touch panel control part that supplies power to the touch panel and supplies the power only to an area which is an area of the touch panel and corresponds to an area of the button image displayed on the display part.

2. The apparatus of claim 1, wherein when an arrangement of the button image displayed on the display part is changed, the touch panel control part changes the area to which the power is supplied according to the arrangement of the button image.

3. The apparatus of claim 1, wherein the touch panel includes
a plurality of first light-emitting elements which are arranged at one end, in a vertical direction, of the display area and on a side of the end and each of which emits light,
a plurality of first light-receiving elements which are arranged at the other end, in the vertical direction, of the display area and on a side of the end, and each of which receives the light emitted from each of the first light-emitting elements,
a plurality of second light-emitting elements which are arranged at one end, in a horizontal direction, of the display area and on a side of the end and each of which emits light, and
a plurality of second light-receiving elements which are arranged at the other end, in the horizontal direction, of the display area and on a side of the end and each of which receives the light emitted from each of the second light-emitting elements, and
the touch panel control part supplies the power only to the first light-emitting element, the first light-receiving element, the second light-emitting element and the second light-receiving element, which emit the light and receive the light in the area of the button image displayed on the display part.

4. The apparatus of claim 3, wherein when the first light-receiving element and the second light-receiving element do not receive the light from the first light-emitting element and the second light-emitting element to emit the light in the area of the button image displayed on the display part, the touch panel control part detects depression of the button image.

5. The apparatus of claim 3, wherein when a plurality of the button images are displayed, the display part displays the button images to cause the button images to overlap each other in one of the vertical direction and the horizontal direction of the display area.

6. The apparatus of claim 5, wherein the display part displays the button images in which sizes in one of or both of the horizontal direction and the vertical direction are equal to each other.

7. The apparatus of claim 1, wherein the touch panel includes
a plurality of first light-emitting elements which are arranged at one end, in a vertical direction, of the display area and on a side of the end and each of which emits light,
a plurality of first light-receiving elements which are arranged at the other end, in the vertical direction, of the display area and on a side of the end and each of which receives the light emitted from each of the first light-emitting elements,
a plurality of second light-emitting elements which are arranged at one end, in a horizontal direction, of the display area and on a side of the end and each of which emits light, and
a plurality of second light-receiving elements which are arranged at the other end, in the horizontal direction, of the display area and on a side of the end and each of which receives the light emitted from each of the second light-emitting elements, and
the touch panel control part supplies the power only to the first light-emitting element, the first light-receiving element, the second light-emitting element and the second light-receiving element, which emit the light and receive the light in a part of the area of the button image displayed on the display part.

8. The apparatus of claim 1, wherein the touch panel is a resistive touch panel including a plurality of first resistive layers arranged to divide the display area of the display part in a vertical direction, and a plurality of second resistive layers arranged to divide the display area of the display part in a horizontal direction.

9. The apparatus of claim 8, wherein the touch panel control part supplies the power only to the resistive layer overlapping the area of the button image displayed on the display part among the plurality of first resistive layers and the plurality of second resistive layers.

10. The apparatus of claim 1, wherein
the display part displays a grayed out button image for a button image not accepting depression of a user, and
the touch panel control part does not supply the power to an area of the touch panel corresponding to an area of the grayed out button image displayed on the display part.

11. A power control method of an input apparatus including a touch panel, wherein
the input apparatus
displays one or a plurality of button images in a display area, and
supplies power to the touch panel and supplies the power only to an area which is an area of the touch panel and corresponds to an area of the button image.

12. The method of claim 11, wherein when an arrangement of the displayed button image is changed, the input apparatus changes the area to which the power is supplied according to the arrangement of the button image.

13. The method of claim 11, wherein the touch panel includes
a plurality of first light-emitting elements which are arranged at one end, in a vertical direction, of the display area and on a side of the end and each of which emits light,
a plurality of first light-receiving elements which are arranged at the other end, in the vertical direction, of the display area and on a side of the end and each of which receives the light emitted from each of the first light-emitting elements,
a plurality of second light-emitting elements which are arranged at one end, in a horizontal direction, of the display area and on a side of the end and each of which emits light, and
a plurality of second light-receiving elements which are arranged at the other end, in the horizontal direction, of the display area and on a side of the end and each of which receives the light emitted from each of the second light-emitting elements, and
the input apparatus supplies the power only to the first light-emitting element, the first light-receiving element, the second light-emitting element and the second light-receiving element, which emit the light and receive the light in the area of the button image.

14. The method of claim 13, wherein when the first light-receiving element and the second light-receiving element do not receive the light from the first light-emitting element and the second light-emitting element to emit the light in the area of the displayed button image, the input apparatus detects depression of the button image.

15. The method of claim 13, wherein when a plurality of the button images are displayed, the input apparatus displays the button images to cause the button images to overlap each other in one of the vertical direction and the horizontal direction of the display area.

16. The method of claim 15, wherein the input apparatus displays the button images in which sizes in one of or both of the horizontal direction and the vertical direction are equal to each other.

17. The method of claim 11, wherein the touch panel includes
a plurality of first light-emitting elements which are arranged at one end, in a vertical direction, of the display area and on a side of the end and each of which emits light,
a plurality of first light-receiving elements which are arranged at the other end, in the vertical direction, of the display area and on a side of the end and each of which receives the light emitted from each of the first light-emitting elements,
a plurality of second light-emitting elements which are arranged at one end, in a horizontal direction, of the display area and on a side of the end and each of which emits light, and
a plurality of second light-receiving elements which are arranged at the other end, in the horizontal direction, of the display area and on a side of the end and each of which receives the light emitted from each of the second light-emitting elements, and
the input apparatus supplies the power only to the first light-emitting element, the first light-receiving element, the second light-emitting element and the second light-receiving element, which emit the light and receive the light in a part of the area of the displayed button image.

18. The method of claim 11, wherein the touch panel is a resistive touch panel including a plurality of first resistive layers arranged to divide the display area in a vertical direction, and a plurality of second resistive layers arranged to divide the display area in a horizontal direction.

19. The method of claim 18, wherein the input apparatus supplies the power only to the resistive layer overlapping the area of the displayed button image among the plurality of first resistive layers and the plurality of second resistive layers.

20. The method of claim 11, wherein
the input apparatus displays a grayed out button image for a button image not accepting depression of a user, and
the power is not supplied to an area of the touch panel corresponding to an area of the displayed grayed out button image.
